(19) United States
(12) Patent Application Publication
(10) Pub. No.: US 2006/0089244 A1
(43) Pub. Date: Apr. 27, 2006

(54) Carton manipulation and feeder apparatus

(76) Inventor: Pascal Martini, Le Poinconnet (FR)

Correspondence Address: MEADWESTVACO CORPORATION;LAW DEPARTMENT, 4850 NORTH CHURCH LANE, SUITE D, SMYRNA, GA, 30080, US

(21) Appl. No.: 11/208,105

(22) Filed: Aug. 19, 2005

Related U.S. Application Data
(63) Continuation of application No. PCT/US04/04697, filed on Feb. 19, 2004.

(30) Foreign Application Priority Data
Feb. 19, 2003 (GB) 0303805.6
Jul. 11, 2003 (GB) 0316244.3

(51) Int. Cl. B31B 1/80

(52) U.S. Cl. 493/315

(57) ABSTRACT

An apparatus for withdrawing from a carton feed hopper collapsed cartons having oppositely disposed panels and for initiating set up thereof, comprises carton pick-up means for sequentially engaging one of the opposed panels and for withdrawing from the hopper a collapsed carton which includes the one panel, and means for transferring the carton orbitally about a primary generally horizontal axis from the hopper to an infeed end of a packaging machine. Panel engaging means is provided within the path of orbit for engaging the other of the panels in a manner to pull the other panel in a direction away from the carton pick-up means so as to initiate opening of the carton.

This is a continuation of international application No. PCT/US2004/004697, filed Feb. 19, 2004, which is hereby incorporated by reference.

### BACKGROUND OF THE INVENTION

This invention is concerned with carton manipulation and feeder apparatus.

This invention relates to packaging of primary articles in sleeve type cartons and is more particularly concerned with a carton feed and transfer apparatus arranged to feed such cartons in collapsed condition from a hopper and for initiating a set up operation of the cartons in sequence, before transferring the partially set up carton to the infeed end of a packaging machine.

U.S. Pat. No. 3,575,409 discloses a carton feeder mechanism wherein motion of the cooperating parts is basically rotary in nature and without sharp and sudden changes in the direction or movement of the parts so as to accommodate high-speed operation of the mechanism.

U.S. Pat. No. 3,991,660 discloses a carton expander mechanism for sequentially manipulating collapsed open ended sleeve type cartons out of a hopper and into set up open ended condition by a main feeder arm for sequentially engaging a lower carton wall to withdraw the associated carton from the hopper together with a supplementary feeder arm pivotally mounted on the main feeder arm and arranged with an end portion thereof adapted to project through an aperture in the lower carton wall so as to engage an upper carton face contacting wall thereby to move such wall away from the lower wall to facilitate setting up the collapsed carton.

U.S. Pat. No. 4,537,587 discloses a carton opening mechanism in which a first set of vacuum cups withdraws a collapsed carton from a hopper and swings such carton over into firm engagement with a second set of suction cups so as to condition the collapsed carton for a set up operation. In this patent, it would appear that transverse rotary movement of the first set of cups is tangential rather than radial relative to the carton to be picked up and that the cups would tend to slide along the wall of the carton in the hopper and thus might interfere with the appearance of the carton or with the efficiency of the set up operation. In this patent, the second cups do not move in a direction away from the first suction cups in order to set up the cartons.

U.S. Pat. No. 4,605,393 discloses a carton blank removal, erection and transfer apparatus in which a rotatable element is mounted on a shaft which in turn is mounted on an arm which is pivotally mounted at an end thereof remote from the shaft on which the rotatable pick-up device is mounted. In this arrangement, rotation of the suction cups tends to blemish the cartons and pick-up operation is impaired by sliding movement of the suction cups along the wall of the carton to be picked up.

Other types of orbital carton transfer and erection systems can be found in U.S. Pat. No. 5,102,385 and WO 99/14127.

A problem associated with the prior art is that the throughput of the machine is often restricted by the speed of the hopper. The present invention and its preferred embodiments seek to overcome or at least mitigate the problems of the prior art.

### SUMMARY OF THE INVENTION

According to one aspect of the invention there is provided an apparatus for withdrawing from a carton feed hopper collapsed cartons having oppositely disposed panels and for initiating set up thereof, the apparatus comprising carton pick-up means for sequentially engaging one of said opposed panels and for withdrawing from the hopper a collapsed carton which includes said one panel, means for transferring said carton orbitally about a primary generally horizontal axis from said hopper to an infeed end of a packaging machine, wherein panel engaging means are provided within the path of orbit for engaging an other of said panels in a manner to pull said other panel in a direction away from the said carton pick-up means so as to initiate opening of the carton.

It is an object of the present invention to devise an improved carton transfer and initial set up apparatus of the orbital type which further facilitates high speed packaging and/or which can provide better set up or transfer steps by avoiding supplementary carton opening mechanisms disposed and arranged to operate outside the path of orbit.

Preferably, the panel engaging means are constructed and arranged to disengage from said other panel when said carton has been opened to a predetermined level. The panel engaging means may be adapted to withdraw closer into the path of orbit after disengaging from said other panel.

The carton pick-up means are preferably mounted upon a rotatable member mounted for rotation upon said means for transferring about a secondary axis spaced from but generally parallel to said primary axis.

In a preferred arrangement, the panel engaging means are mounted for rotation upon said means for transferring and adapted to rotate about a supplementary axis spaced from but generally parallel to the primary axis. The means for transferring may comprise a rotor mounted for rotation about the primary axis. In the rotor, the carton pick-up means and the panel engaging means are mounted. Conveniently, the panel engaging means include at least one vacuum cup. Such at least one vacuum cup is preferably mounted upon a rotatable vacuum tube.

Preferably the means for transferring includes a primary fixed cam housing defining a primary orbital cam track and a secondary fixed cam housing defining a secondary orbital cam track, wherein the primary orbital cam track defines orbital motion of the carton pick-up means, and the secondary orbital cam track defines orbital motion of the panel engaging means.

Conveniently the carton pick-up means and the panel engaging means can be connected respectively to primary and secondary cam followers which engage the respective cam tracks in a manner to define their said orbital motion.

The carton pick-up means may comprise an array of vacuum cups affixed to an elongate arm. Conveniently, the carton pick-up means and the panel engaging means may be vacuum operated and in communication with a common vacuum interrupter.

Preferably the apparatus is arranged, in use, to at least partially open the carton by more than 90 degrees preferably up to about 120 degrees to indicate folds in the carton to be formed and to prevent the partially set up carton from reverting to its original shape.

Preferably, the secondary fixed cam housing is mounted concentrically within the primary fixed cam housing in relation to the primary axis.

A second aspect of the invention provides a method of forming the carton comprising the steps of withdrawing from a carton feed hopper collapsed cartons having oppositely disposed panels and for initiating set up thereof, sequentially engaging one of said opposed panels and for withdrawing from the hopper a collapsed carton which includes said one panel, transferring said carton orbitally about a primary generally horizontal axis from said hopper to an infeed end of a packaging machine, and for engaging another of said panels in a manner to pull said other panel in a direction away from the said carton pick-up means so as to initiate opening of the carton.

### BRIEF DESCRIPTION OF THE DRAWINGS

In order that the invention may be illustrated, more easily appreciated and readily carried into effect by those skilled in the art, a preferred embodiment of the invention will now be described purely by way of non-limiting example with reference to the accompanying drawings, wherein:

FIG. 1 is an isometric view of one embodiment of an orbital carton manipulation and feeding apparatus;

FIG. 2 is a partial cut-away section on the axis of the rotatable shaft of the apparatus of FIG. 1 with fixed cam housing removed;

FIG. 3 corresponds to the arrangement of FIG. 2 but wherein the carton pick-up means has progressed in the direction of arrow A to an initial carton opening configuration;

FIG. 4 also corresponds generally with the FIG. 2 configuration, but wherein the carton has become erected to a larger extent;

FIG. 5 is a partial cut-away section representing a further stage in orbital transfer beyond the FIG. 4 arrangement, wherein a substantially unfolded, erected carton is being transferred to a belt conveyor at the infeed end of a packaging machine;

FIG. 6 is an isometric view of a second embodiment of an orbital carton manipulation and feeding apparatus;

FIG. 7 is a partial cut-away section on the axis of the rotatable shaft of the apparatus of FIG. 6 with fixed cam housing removed;

FIG. 8 corresponds to the arrangement of FIG. 6 but wherein the carton pick-up means has progressed in the direction of arrow A to an initial carton opening configuration;

FIG. 9 also corresponds generally with the FIG. 6 configuration, but wherein the carton has become erected to a larger extent; and

FIG. 10 is a partial cut-away section representing a further stage in orbital transfer beyond the FIG. 8 arrangement, wherein a substantially unfolded, erected carton is being transferred to a belt conveyor at the infeed end of a packaging machine.

### DETAILED DESCRIPTION OF THE PREFERRED EMBODIMENTS

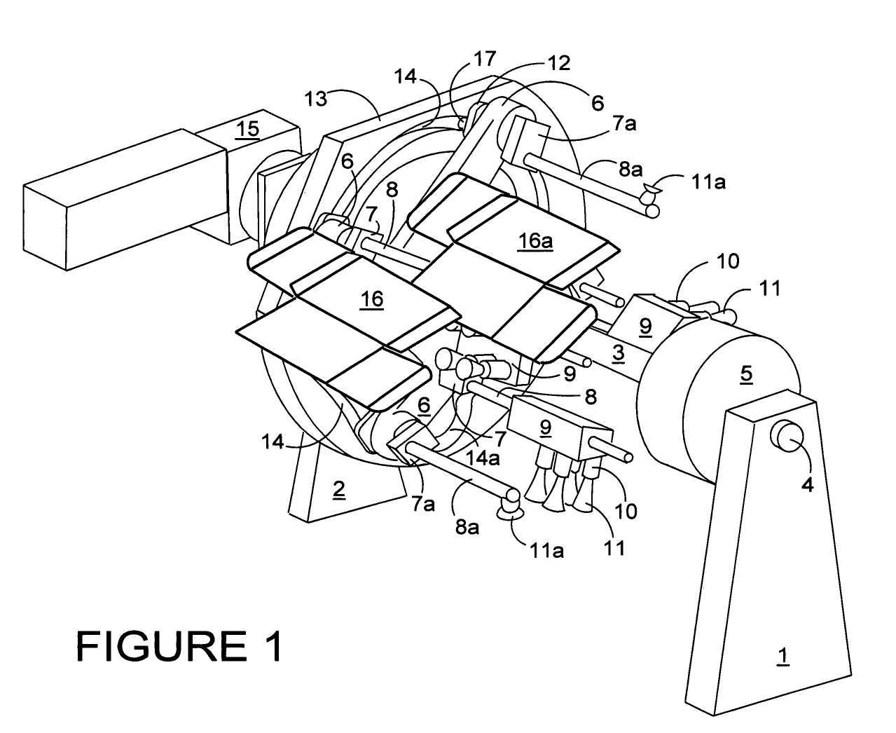

Referring to the drawings and first, to the embodiment of FIG. 1 thereof, an orbital carton manipulation and feeding apparatus is shown, wherein a carton hopper of flat partially assembled carton blanks is present but not shown in the interests of clarity. The cartons fed from the hopper, (not shown), are initially in collapsed form as shown by carton 16 although the cartons become attached to an array of vacuum cups as at 16a to effect withdrawal from the hopper.

The cartons have oppositely disposed flat panels comprising initially front and rear surfaces, each surface of which comprises two adjacent flat panels of the carton. As will be described in more detail hereafter, in the illustrated embodiment the carton pick-up means comprises an assembly of vacuum cups secured to a support affixed to an elongate vacuum tube capable of rotation. When the assembly of vacuum cups is in the appropriate position to engage an underneath surface panel of the carton 16, vacuum is applied whereby further rotation of the apparatus causes the carton positively to be withdrawn from the carton feed hopper. The means for transferring the carton orbitally comprises a motor driven rotor mounted for rotation about the primary axis.

The assembly of vacuum cups holds the carton in position as required during further orbital movement of the rotor, until the carton has been partially opened whereby the carton becomes ready for transfer to the infeed end of the packaging machine. Four supplementary individually mounted vacuum cups also located on the rotor act upon an outer surface panel of the carton 16 to cause that panel to be moved away from the underneath oppositely disposed panels to commence unfolding of the carton. In this embodiment, each supplementary vacuum cup acts as the panel engaging means and all being situated within the path of orbit of the apparatus.

The carton manipulation apparatus illustrated in FIG. 1 includes a pair of upstanding support legs 1, 2 in which a main rotatable shaft 3 is mounted for rotation in suitable bearings 4 of known type and located at the upper-most ends of the support legs 1 and 2. A cylindrical vacuum interrupter 5 of known type is located around the shaft 3 adjacent the primary support leg 1. An orbital rotor 6 is mounted for rotation with the main shaft 3 and, in this embodiment, has four arms extending radially from its central structure attached to the shaft 3. Four radially spaced supporting blocks 7 are mounted in the central structure of the rotor, and to each of which a pick-up arm 8 is connected. Each of the four pick-up arms 8 carry vacuum cup supports 10 and vacuum cups 11 in an array of four such vacuum cups 11. The vacuum cups 11 are in communication, through known means, with the vacuum interrupter 5.

The four arms of the orbital rotor 6 are further provided at an outer region with supporting blocks 7a, each of which carries a supplementary arm 8a, provided with a supplementary vacuum cup 11a. In the embodiment of FIG. 1, there is shown four vacuum cups 11a, each are similarly in communication through known means with the vacuum interrupter 5.

Each support block 7 is mounted for rotation through an aperture (not shown) of the rotor 6. For example, a spigot (not shown) can project from one side of the supporting block 7 through the aperture (not shown) to the cam plate at the remote side thereof. Similarly, supplementary support blocks 7a, are mounted for rotation within the orbital rotor 6, e.g. by means of a spigot projecting through the respective apertures (not shown) in the rotor 6 and also affixed to a cam plate. Such spigots are offset from the longitudinal axis of the vacuum tube 8a so each tube 8a is capable of rotation independently about its spigot in a manner to be determined by rotation of the rotatable shaft 3.

The supporting block 7a shown at the upper part of FIG. 1, at the remote side of the rotor 6, is secured to a cam plate 12 including two cam followers (although only one of which 17 is shown), e.g. a wheel or roller can be used as the cam follower located within an indented orbital cam track 14 in the secondary fixed cam housing 13. Although not apparent from FIG. 1, the mounting arrangement for pick-up arms 8 on which the carton pick-up means 9, 10, 11 are located is similar in that a corresponding spigot projects through other apertures in the central port of the rotor 6 connected to a cam plate having cam followers engaging a primary orbital cam track of a primary fixed cam housing.

The main rotatable shaft 3 is driven by a motor 15, e.g. a linear servo motor, which causes the orbital rotor to rotate about the primary axis of the shaft 3 to provide corresponding motion of each of the four carton pick-up means and each of the four associated panel engaging means as the rotor orbits the fixed cam housings causing rotation and displacement of the arms 8 and 8a, according to the paths of the indented cam tracks in the two fixed cam housings.

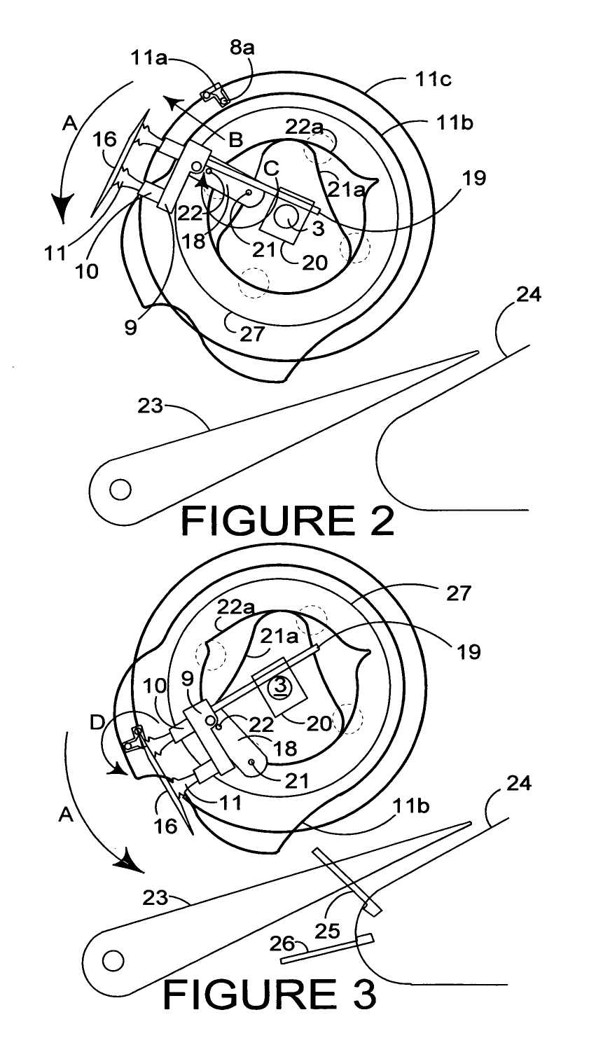

Referring to FIG. 2 of the drawings, there is shown an arrangement depicting the orbital tracks of the main vacuum cup housing 9 including the four arrays of vacuum cups 11 attached thereto, and the orbital path of the four supplementary vacuum cups 11a. Around the main rotating shaft 3, a fixed bracket 20 is provided in which a connecting rod 19 is slidably mounted. The connecting rod is attached to the main vacuum housing 9 and permits radial displacement of the main housing 9 in addition to its rotational motion. Such radial displacement is depicted by arrow B. The vacuum cups 11 attach by vacuum force to carton 16 so as to withdraw such carton from a corresponding hopper (not shown). The main vacuum cup housing 9 is connected to a main cam plate 18 through which spindles 21 and 22 pass and connected on the remote side to cam followers (not shown). Cam plate 18 is not only rotated about the axis of the main rotating shaft 3 but is also adapted to rotate in a direction shown by arrow C according to the respective cam track 21a in which cam follower on spindle 21 is located and track 22a in which cam follower on spindle 22 is located. The orbital route followed by the main vacuum cups 11 is depicted generally at 11c, whereas the orbital route followed by the supplementary vacuum cup 11a is depicted generally at 11b. The boundary between the inner primary fixed cam housing and outer secondary fixed cam housing is depicted generally at 27.

Beneath the orbital carton manipulation and transfer means, there is provided a transfer belt 23 arranged in the direction of the infeed end of a conveyor track 24 upon which the at least partially unfolded cartons are to be transferred.

With reference to FIG. 3, the orbital rotor (not shown) has traveled further in the direction of arrow A whereby the main vacuum cups 11 have been withdrawn towards the interior of the assembly whilst the carton 16 is still attached thereto in a generally flat condition. In this configuration the supplementary vacuum cup 11a (not referenced) has become rotated in the direction of arrow D so that it can apply a vacuum force to an externally disposed panel of the carton 16. The orientation of the main cam plate 18 is such that the cam followers (not shown) attached to the remote ends of the spindles 21 and 22 are now following generally the same part of the track (21a, 22a) simultaneously causing the slidable rod 19 to be displaced linearly within its mounting in the bracket 20. In the FIG. 3 configuration, the apparatus approaches a stage where the carton is about to become partially opened before transfer on to the transfer belt 23. Fixed plates or lugs 25 and 26 are shown embedded in the conveyor track 24 to receive the at least partially unfolded carton as subsequently described.

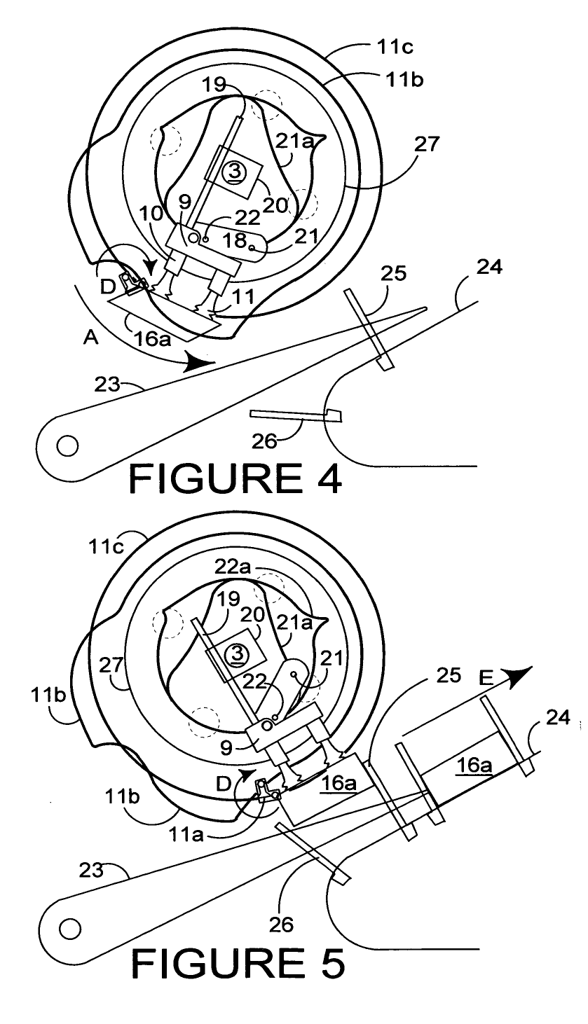

With reference to the FIG. 4 configuration the orbital arm (not shown) has rotated still further in the direction of arrow A and the supplementary vacuum cup 11a (not referenced) has become rotated clockwise in the direction D causing an at least partial opening of the carton 16a. The position of the main vacuum cup holder 9 radially corresponds generally with the arrangement in FIG. 3 as such displacement is effectively controlled by the cam tracks in which the cam followers (not shown) attached to the spindles 21 and 22 are engaged. The partially unfolded carton 16a approaches still closer to the transfer belt 23 in this arrangement.

With reference to FIG. 5, the orbital rotor (not shown) has continued its rotary motion to a further stage whereby the supplementary vacuum cup 11a detaches itself from the panel to which it was attached (in FIG. 4) and becomes separated from the opened carton 16a by virtue of the track 11b followed by the vacuum tube (8a in FIG. 2). The main vacuum cup holder 9 is about to be further withdrawn radially towards the primary axis of the main shaft 3 whilst the carton 16a becomes engaged between the lugs or plates 25 and 26 at the infeed end of the conveyor 24. Accordingly upon still further rotation of the orbital rotor (not shown) the supplementary vacuum cup 11a becomes fully disengaged and withdrawn closer into the primary axis of the assembly, the vacuum supplied to the main vacuum cups 11 is disconnected and these vacuum cups also become withdrawn closer into the primary axis of the main rotating shaft 3 thereby becoming detached from the opened carton which by then has become engaged between the lugs or plates 25 and 26 moving in the direction of arrow E at the infeed end of conveyor 24, for insertion of product or other processing.

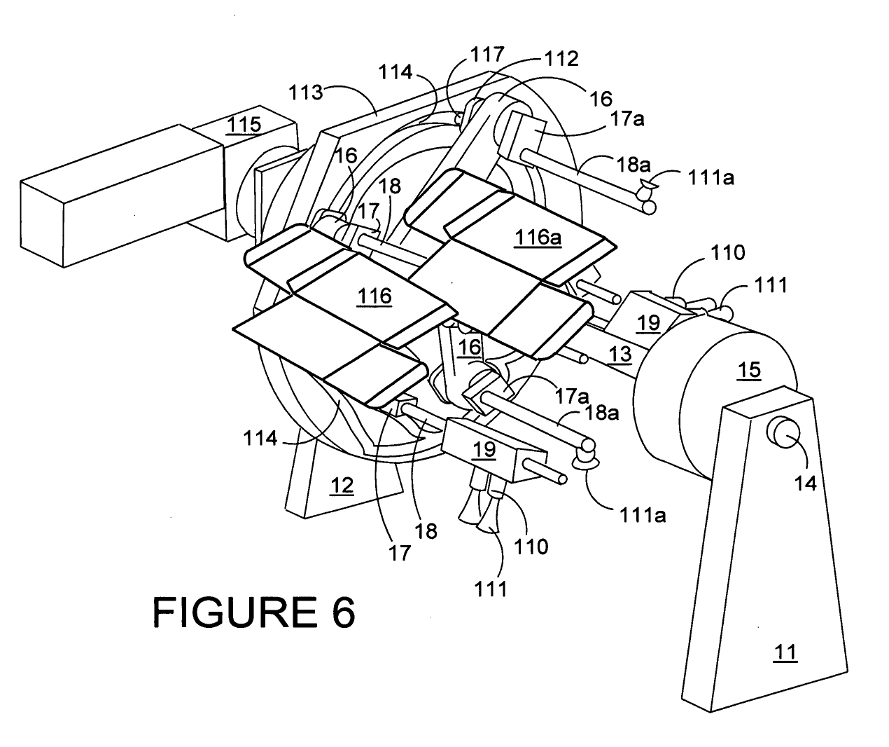

The second embodiment of the orbital carton manipulation and feed apparatus is shown in FIGS. 6 to 10. The apparatus is similar to the first embodiment in many respects and, therefore, like reference numerals have been used, with the prefix “1”. Therefore, only the differences will be described in any great detail.

In the second embodiment, the panel engaging means is positioned in advance of the carton pick-up means, so as to engage a leading edge of the collapsed carton 116. (In the first embodiment, the engaging means contacts a trailing face of carton.)

As illustrated in FIG. 6, the four arms of the orbital rotor 16 are further provided at an outer region with supporting blocks 17a, each of which carries a supplementary arm 18a, provided with a supplementary vacuum cup 111a. In the embodiment of FIG. 6, four vacuum cups 111a are similarly in communication through known means with the vacuum interruptor 15.

Each of the four pick-up arms 18 carry vacuum cup supports 110 and vacuum cups 111, in this embodiment, in an array of two such vacuum cups 111. Again, the vacuum cups 111 are in communication through known means with the vacuum interrupter 15. It will be seen from FIG. 6 that the supplementary vacuum cup 111a is positioned ahead of vacuum cups 111 in the direction of motion, so that the supplementary vacuum cup 111a can engage the leading face of the carton 116.

The remaining features of the apparatus according to the second embodiment shown in FIG. 6, correspond to those features illustrated in FIG. 1 and are described in the preceding paragraphs.

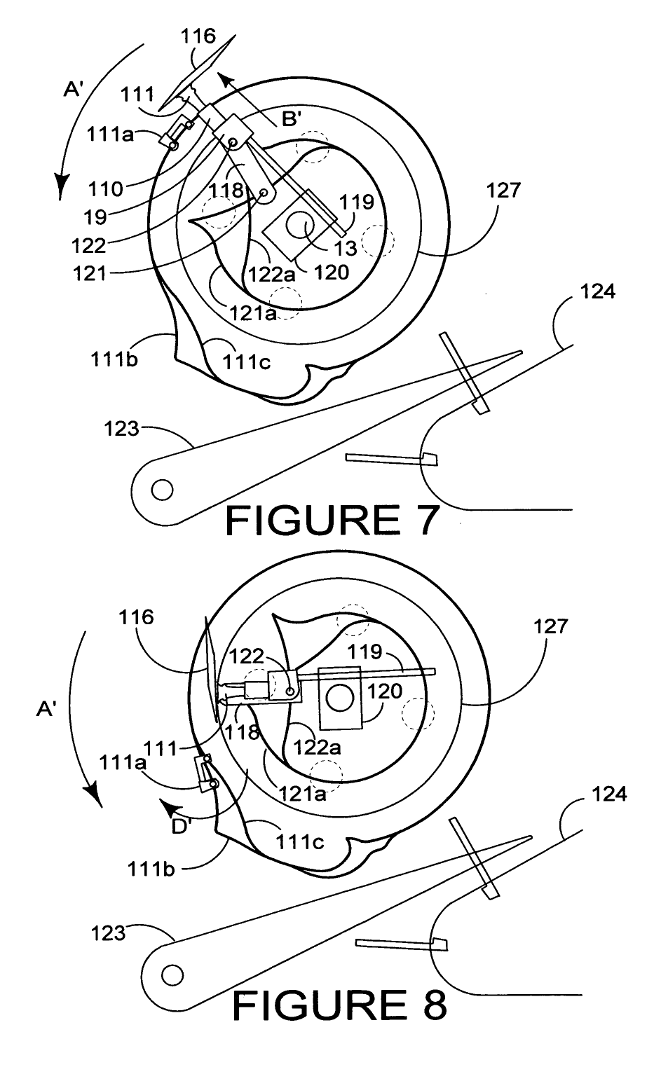

Referring to FIG. 7 of the drawings, there is shown an arrangement depicting the orbital tracks of the main vacuum cup housing 19 including the four arrays of vacuum cups 111 attached thereto, and the orbital path A′ of the four supplementary vacuum cups 111a. Around the main rotating shaft 13, a fixed bracket 120 is provided in which a connecting rod 119 is slidably mounted. The connecting rod is attached to the main vacuum housing 19 and permits radial displacement of the main housing 19 in addition to its rotational motion. Such radial displacement is depicted by arrow B′. The vacuum cups 111 attach by vacuum force to carton 116 so as to withdraw such carton from a corresponding hopper (not shown). The main vacuum cup housing 19 is connected to a main cam plate 118 through which spindles 121 and 122 pass and connected on the remote side to cam followers (not shown). Cam plate 118 is not only rotated about the axis of the main rotating shaft 13 but is also adapted to rotate according to the respective cam track 121a in which cam follower on spindle 121 is located and track 122a in which cam follower on spindle 122 is located. The orbital route followed by the main vacuum cups 111 is depicted generally at 111c, whereas the orbital route followed by the supplementary vacuum cup 111a is depicted generally at 111b. The boundary between the inner primary fixed cam housing and outer secondary fixed cam housing is depicted generally at 127.

Beneath the orbital carton manipulation and transfer means, there is provided a transfer belt 123 arranged in the direction of the infeed end of a conveyor track 124 upon which the at least partially unfolded cartons are to be transferred.

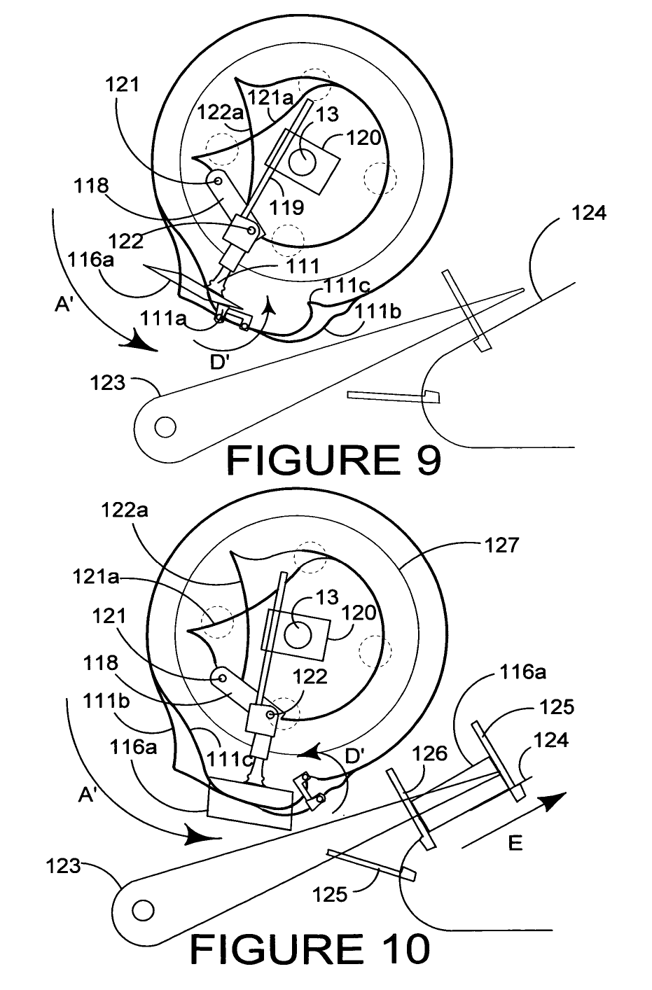

With reference to FIG. 8, the orbital rotor (not shown) has traveled further in the direction of arrow A′ whereby the main vacuum cups 111 have been withdrawn towards the interior of the assembly whilst the carton 116 is still attached thereto in a generally flat condition. In this configuration the supplementary vacuum cup 111a is rotated in the direction of arrow D′ so that it can apply a vacuum force to an externally disposed leading panel of the carton 116. The orientation of the main cam plate 118 is such that the cam followers (not shown) attached to the remote ends of the spindles 121 and 122 are now following generally the same part of the track (121a, 122a) simultaneously causing the slidable rod 119 to be displaced linearly within its mounting in the bracket 120. In the FIG. 9, the apparatus approaches a stage where the carton is about to become partially opened before transfer on to the transfer belt 123. Fixed plates or lugs 125 and 126 are shown embedded in the conveyor track 24 to receive the at least partially unfolded carton as subsequently described.

With reference to the FIG. 9 configuration the orbital arm (not shown) has rotated still further in the direction of arrow A′ and the supplementary vacuum cup 111a (not referenced) has become rotated clockwise in the direction D1 causing an at least partial opening of the carton 116a. The position of the main vacuum cup holder 19 radially corresponds generally with the arrangement in FIG. 8, but the cam plate 118 is caused to be moved out of alignment with rod 119 as such displacement is effectively controlled by the cam tracks in which the cam followers (not shown) attached to the spindles 121 and 122 are engaged. The partially unfolded carton 116a approaches still closer to the transfer belt 123 in this arrangement.

With reference to FIG. 10, the orbital rotor (not shown) has continued its rotary motion to a further stage whereby the supplementary vacuum cup 111a detaches itself from the panel to which it was attached (in FIG. 9) and becomes separated from the opened carton 116a by virtue of the track 111b followed by the arm (18a in FIG. 7). The main vacuum cup holder 19 is about to be further withdrawn radially towards the primary axis of the main shaft 13 whilst the carton 116a becomes engaged between the lugs or plates 125 and 126 at the infeed end of the conveyor 124. Accordingly, upon still further rotation of the orbital rotor (not shown) the supplementary vacuum cup 111a becomes fully disengaged and withdrawn closer into the primary axis of the assembly in direction D1. The vacuum supplied to the main vacuum cups 111 is disconnected and these vacuum cups also become withdrawn closer into the primary axis of the main rotating shaft 13 thereby becoming detached from the opened carton which by then has become engaged between the lugs or plates 125 and 126 moving in the direction of arrow E at the infeed end of conveyor 24, for insertion of product or other processing.

The present arrangement provides a number of advantages over known such arrangements for withdrawing cartons from feed hoppers and transferring them orbitally in that it is possible to avoid the complexity, cost and synchronization of carton-opening components situated outside of the orbital path of the carton blanks by deploying supplementary vacuum cups which can be affixed to the same rotor as the main carton withdrawing vacuum cups through use of a supplementary fixed cam housing to define their motion. Also as is apparent particularly from the FIGS. 3 and 9 arrangement the supplementary vacuum cup 11a and 111a engages a minimum edge part of the carton to assist in partial opening thereof to minimize the risk of such vacuum cup sliding on or unintentionally disengaging from the surface panel including that edge.

Such an arrangement in consequence can provide a further level of improved operation at higher speeds than similar known such equipment which can lead to efficiencies in the packaging process.

What is claimed is:

1. An apparatus for withdrawing from a carton feed hopper collapsed cartons each having oppositely disposed panels and for initiating set up thereof, the apparatus comprising carton pick-up means for sequentially engaging one of the oppositely disposed panels and for withdrawing from the hopper a collapsed carton which includes said one oppositely disposed panel, transfer means for transferring said carton orbitally about a generally horizontal primary axis from said hopper to an infeed end of a packaging machine, wherein the apparatus further comprises panel engaging means for engaging the other of said oppositely disposed panels, the panel engaging means being mounted upon a rotatable member for rotation upon the transfer means and for rotation about a supplementary axis spaced from but generally parallel to said primary axis, wherein the engaging means is rotated from a position substantially opposing the pick-up means to a position adjacent the pick-up means such that the engaging means is drawn within a path of orbit of the pick-up means in such a manner to pull said other panel in a direction away from the pick-up means so as to initiate opening of the carton.

2. An apparatus as claimed in claim 1, wherein the engaging means is constructed and arranged to disengage from said other panel when said carton has been opened to a predetermined level.

3. An apparatus as claimed in claim 2, wherein the engaging means is adapted to withdraw closer into the path of orbit after disengaging from said other panel.

4. An apparatus as claimed in claim 1 wherein said pick-up means is mounted upon a rotatable member for rotation upon said transfer means about a secondary axis spaced from but generally parallel to said primary axis.

5. An apparatus as claimed in claim 1 wherein said transfer means comprises a rotor mounted for rotation about said primary axis, and wherein said carton pick-up means and said panel engaging means are mounted in said rotor.

6. An apparatus as claimed in claim 1 wherein said engaging means includes at least one vacuum cup.

7. An apparatus as claimed in claim 6 wherein said at least one vacuum cup is mounted upon a rotatable arm.

8. An apparatus as claimed in claim 1 wherein the transfer means includes a primary fixed cam housing defining a primary orbital cam track and a secondary fixed cam housing defining a secondary orbital cam track, wherein the primary orbital cam track defines orbital motion of the pick-up means, and the secondary orbital cam track defines orbital motion of the engaging means.

9. An apparatus as claimed in claim 8 wherein said pick-up means and said engaging means are connected to primary and secondary cam followers which engage said cam tracks in a manner to define said orbital motion.

10. An apparatus as claimed in claim 1 wherein said pick-up means comprises an array of vacuum cups affixed to an elongate vacuum tubular member.

11. An apparatus as claimed in claim 1 wherein said pick-up means and said engaging means are vacuum operated and in communication with a common vacuum interrupter.

12. An apparatus as claimed in claim 8 wherein the secondary fixed cam housing is mounted concentrically with the primary fixed cam housing in relation to the primary axis.

13. A method of forming a carton comprising the steps of withdrawing from a carton feed hopper collapsed cartons having oppositely disposed panels and for initiating set up thereof, sequentially engaging one of said oppositely disposed panels and for withdrawing from the hopper a collapsed carton which includes said one oppositely disposed panel, transferring said carton orbitally about a primary generally horizontal axis from said hopper to an infeed end of a packaging machine, and engaging the other of said oppositely disposed panels in a manner to pull said other panel in a direction away from the said carton pick-up means so as to initiate opening of the carton.
